(19) United States
(12) Patent Application Publication
(10) Pub. No.: US 2016/0012179 A1
(43) Pub. Date: Jan. 14, 2016

(54) METHOD FOR MANAGING DATA RELATIVE TO MOTOR VEHICLES WITH A VIEW TO THE SUBSEQUENT GRAPHIC GENERATION OF ELECTRICAL DIAGRAMS OF ELECTRICAL SYSTEMS

(71) Applicant: RENAULT S.A. S., Boulogne Billancourt (FR)

(72) Inventor: Nouman ZOUKARI, Les Ulis (FR)

(73) Assignee: RENAULT s.a. s., Boulogne Billancourt (FR)

(21) Appl. No.: 14/767,778

(22) PCT Filed: Feb. 28, 2014
(86) PCT No.: PCT/FR14/50444

§ 371 Date: Aug. 13, 2015

(30) Foreign Application Priority Data
Mar. 4, 2013 (FJ) 1351904

(51) Int. Cl. G06F 17/50

(52) U.S. Cl. CPC G06F 17/5095; G06F 17/509

(57) ABSTRACT

A method for managing data relative to motor vehicles with a view to the subsequent graphic generation of electrical diagrams of electrical systems. The method for managing data relative to motor vehicles with a view to the subsequent graphic generation of electrical diagrams of electrical systems, makes it possible to generate a set of elements by a computer, each element of the set including an electrical system from a list of electrical systems, and an associated vehicle configuration from a list of configurations, and each element determining, preferably potentially, an electrical diagram to be generated.

### TECHNICAL FIELD OF THE INVENTION

The invention relates to the automotive field.

The subject of the invention is more particularly a method for managing data relating to automotive vehicles with a view to the subsequent graphical generation of electrical diagrams of electrical systems.

Another subject of the invention is a method of graphical generation of electrical diagrams comprising at least one step of implementing the method for managing data.

### PRIOR ART

An automotive vehicle comprises a plurality of electrical systems such as for example a parking brake, an airbag, etc. In general each of these electrical systems comprises a plurality of components. These components are connected so as to provide an electrical function of the electrical system concerned.

Generally, from one vehicle to another, from one and the same range or from a different range, the components are substantially the same and are substantially disposed at similar locations of the vehicle. Nonetheless, the connection technologies are often different. This results in an appreciable number of configurations that the automobile manufacturer must manage.

This number of configurations further complicates after-sales service repairs or servicing. In order to provide an after-sales service benefit, the workshop in charge of after-sales service must be capable of rapidly identifying a fault and of having all the information relating to the electrical system concerned.

This results in appreciable work upstream to identify all the possible configurations and prepare associated electrical diagrams with a view to being used by a workshop within the framework of an after-sales service benefit. Indeed, the current methodology leads to the generation of a significant quantity of graphical electrical diagrams for each vehicle configuration and then to their sorting with a view to finalizing the vehicle manuals. Stated otherwise, the current methodology generates a significant loss of time.

Hence, a need exists to improve the process related to the production, integration and publication of electrical diagrams intended to be used by the workshops of the after-sales network with a view to carrying out diagnostics.

### OBJECT OF THE INVENTION

The aim of the present invention is to propose a solution which remedies the drawbacks listed hereinabove.

This aim is addressed by virtue of a method for managing data relating to automotive vehicles with a view to the subsequent graphical generation of electrical diagrams of electrical systems, said method comprises the following steps:
transmitting to a computer a collection of data relating to electrical systems of automotive vehicles and to configurations of automotive vehicles, said collection arising from a database,
selecting, by the computer, on the basis of the collection of data a list of electrical systems and a list of vehicle configurations,
generating a set of elements by the computer, each element of the set comprising an electrical system arising from the list of electrical systems and an associated vehicle configuration arising from the list of configurations, and each element determining, preferably potentially, an electrical diagram to be generated.

Preferably, the step of generating the set of elements comprises:
a step of identifying at least two elements each comprising an electrical system of the same nature and whose associated vehicle configurations are distinct, and
a step of comparing parameters of the electrical systems of the same nature so that if the latter are identical, only one element of said at least two elements is included in the set of elements.

For example, a linking step links vehicle configurations whose electrical systems have identical contents, to one and the same item of information, in particular by an electrical diagram identifier.

Advantageously, the step of generating the set of elements comprises, for each electrical system of the corresponding list, a step of verifying the membership of said electrical system in each of the vehicle configurations of the corresponding list.

The method can furthermore comprise a step of forming an element upon each positive verification of membership of the electrical system in a given configuration, said element formed being added to the set of elements or compared with one or more other elements already present in the set of elements so as to determine whether it should be added to the set of elements.

According to an implementation, the step of generating the set of elements comprises the filling of a matrix each row of which is associated with an electrical system and each column of which is associated with a vehicle configuration, each row of the matrix comprising at least one association with a column of the matrix, said association corresponding to an element of the set of elements.

For example, the association of a row of the matrix and of a column of the matrix corresponds to placing at this location of the matrix a pointer to a structure of data of electrical functions comprising contents of the electrical system associated with the configuration, in particular a list of ins and outs.

According to a mode of execution, the management method comprises for each element of the set a processing step comprising the following steps:
transmitting a model arising from the database to the computer, said model comprising a list of identifiers of components of the electrical system, and, for each component identifier, a position of said component on the electrical diagram to be generated,
determining, by the computer, a configuration of the electrical diagram to be generated, said configuration including a plurality of connectors,
associating, by the computer, with each component at least one connector of the plurality of connectors,
determining, by the computer, a topology of the electrical diagram to be generated, said topology comprising linking elements, each linking element linking at least two connectors.

The invention also relates to a method of graphical generation of electrical diagrams, comprising the following steps:
the implementation of the method for managing data such as described,
the graphical generation, for each element of the set of elements, of an electrical diagram of the associated electrical system by transmission of data relating to said element to a drawing device.

The invention also relates to a data recording medium readable by a computer, on which is recorded a computer program comprising computer program code means for the implementation of the steps of a management method such as described or of a graphical generation method such as described.

### SUMMARY DESCRIPTION OF THE DRAWINGS

Other advantages and characteristics will emerge more clearly from the description which follows of particular embodiments of the invention which are given by way of nonlimiting examples and are represented in the appended drawings, in which:

FIG. 1 schematically illustrates a particular mode of execution of the management method,

FIG. 2 illustrates a matrix which can be obtained during a step of the method,

FIG. 3 illustrates the matrix of FIG. 2 filled in,

FIG. 4 illustrates in greater detail a step of processing of the management method of FIG. 1,

FIG. 5 illustrates a computer intended to be used within the framework of the management method,

FIGS. 6 to 10 are views graphically representing digital data at various junctures of the processing method,

FIG. 11 illustrates a method of graphical generation of electrical diagrams,

FIG. 12 illustrates a particular mode of execution of the step of processing of the management method.

### DESCRIPTION OF PREFERENTIAL MODES OF THE INVENTION

The data management method described hereinafter differs from what it has been possible to see in the prior art through particularly adapted management of the data in particular upstream of the graphical production of the electrical diagrams with the aim of speeding up the processing of the data with a view to the production of said electrical diagrams, in particular while optimizing the amount of work to be carried out subsequently in generating the electrical diagrams.

As illustrated in FIG. 1, a method for managing data relating to automotive vehicles with a view to the subsequent graphical generation of electrical diagrams of electrical systems can comprise a step E1 in which a collection of data relating to electrical systems of automotive vehicles and to configurations of automotive vehicles is transmitted to a computer. The collection advantageously arises from a database.

By “electrical system” is understood a system intended to provide a function of a vehicle. An electrical system can therefore be chosen, by way of nonlimiting example, from the following list: an air-conditioning, an electric window, a display, an electric parking brake, etc. An electrical system can comprise a plurality of components associated with a list of electrical connections in the form of ins-outs, also called inputs-outputs, defining the components' interconnection topology. In fact, the ins-outs describe solely the connections between the components used for an electrical system, in particular through connectors and unions.

Two electrical systems of the same nature can comprise one and the same list of components but lists of different ins-outs or else a list of different components. Electrical systems are considered to be identical when they comprise the same components and the same lists of ins-outs. The components and/or ins-outs can then be parameters or a content of an electrical system. For example, a bottom-of-the-range air-conditioning and a top-of-the-range air-conditioning are two electrical systems of the same nature and may comprise the same components, however the links between these components may be different so that certain functionalities of the top-of-the-range air-conditioning are not activated in the bottom-of-the-range air-conditioning.

By “configuration” of a vehicle is understood for example a vehicle identifier making it possible to identify a type of vehicle, or a version/range of a vehicle within a type of vehicle. A configuration may typically comprise a plurality of electrical systems.

Two different vehicle configurations may comprise electrical systems that are identical or of the same nature but whose ins-outs are different, thus providing for different services.

The data collection such as described can correspond to the various configurations of the vehicles to be processed; it can in particular entail the design data of the electrical systems of the vehicles which comprise for each electrical function a file representative of a list of ins-outs and/or of a list of components.

The method furthermore comprises a step of selection E2, by the computer, on the basis of the data collection, of a list of electrical systems and of a list of configurations of automotive vehicles. Preferably, all the electrical systems of the vehicle are processed, one by one, for each of the configurations retained by the collections.

Thereafter, the method comprises a step E3 of generation of a set of elements by the computer. Each element of the set of elements comprises an electrical system arising from the list of electrical systems and an associated vehicle configuration arising from the list of configurations. In fact, an association between an electrical system and a vehicle configuration can be produced when the electrical system actually forms an integral part of the configuration of the vehicle. Each element of the set of elements determines, preferably potentially (in fact the set of elements may comprise either only different electrical systems, or identical electrical systems that will have to be preferentially sorted later), an electrical diagram to be generated. Thus, this makes it possible to decrease the work time in the sense that, later, only the electrical diagrams of the associations will be generated graphically. Preferably, only the different electrical diagrams (of different electrical function or of the same nature but with different ins-outs), according to the associations retained, then form part of the set generated and will be generated graphically. Furthermore, the selection and the formation of the set makes it possible thereafter to decrease the number of cycles of the computer to produce the diagrams.

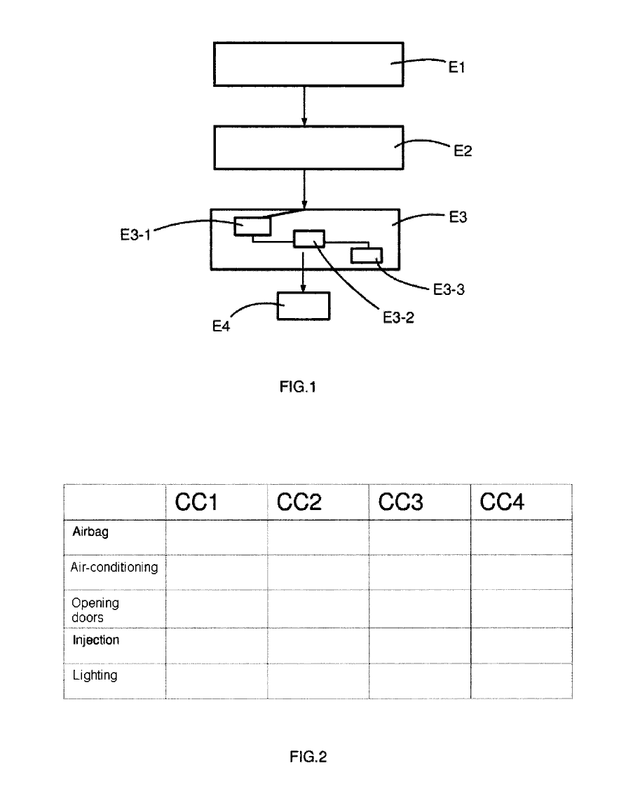

This set of elements can be generated in the form of a matrix comprising for each row an electrical system and for each column a vehicle configuration. Advantageously, in this case the configurations of vehicles are all different and the electrical systems are all of a different nature. Stated otherwise, the step E3 of generating the set of elements can comprise the filling of a matrix each row of which is associated with an electrical system (arising from the list of electrical systems) and each column of which is associated with a vehicle configuration (arising from the list of configurations), each row of the matrix comprises, in particular at the end of the filling of the matrix, at least one association with a column of the matrix, said association corresponding to an element of the set of elements. Such a matrix can be of the type of that illustrated in FIG. 2 which comprises in the example four configurations identified respectively by CC1, CC2, CC3, CC4 and five electrical systems, respectively an airbag, an air-conditioning, a system for opening the doors, an injection control and a lighting system. This matrix can be formed in the course of the step E2 of selecting on the basis of the two associated lists and then filled in in the course of step E3 of generating the set of elements. At the end of its filling, that is to say when all the electrical systems have been processed so as to verify their associations with the configurations, the empty rows of the matrix that is to say not containing any association are deleted. This makes it possible to deal with a problematic issue of optimizing the equipment of the computer, for example by limiting the memory size occupied by the matrix during the computations performed by the computer.

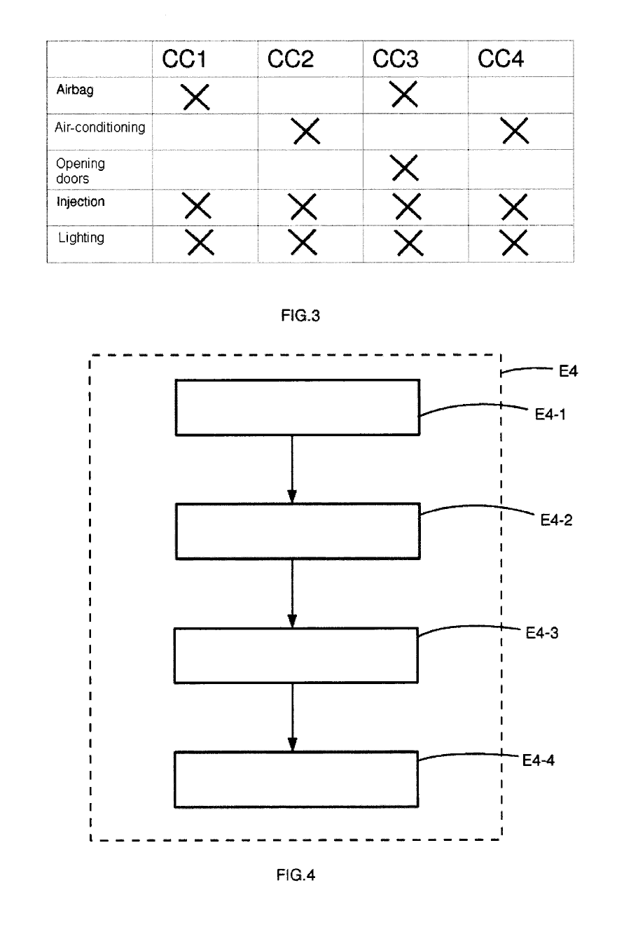

This association can be implemented by placing an indicator or an object in the box corresponding to the intersection between the corresponding row of the matrix and the corresponding column of the matrix. Stated otherwise, the matrix makes it possible to exactly identify the diagrams to be generated. In FIG. 3, the matrix is filled in, the airbag is present in configurations CC1 and CC3, the air-conditioning in configurations CC2 and CC4, the opening of the door in configuration CC3, the injection control and the lighting system are present in all the configurations. Stated otherwise, if the example of the airbag is taken, the latter has to be generated for configurations CC1 and CC3. The precomputation proposed by this innovative method shows that it is unnecessary to generate them for CC2 and CC4: the only distinct configurations related to the airbag system are CC1 and CC3. By way of example, the association of a row of the matrix and of a column of the matrix corresponds to placing at this location of the matrix a pointer to a structure of electrical function data, for example a set of records in the base which contains the elements related to the electrical functions comprising parameters of the electrical system associated with the configuration. In particular this data structure comprises contents of the electrical system associated with the configuration, for example a list of ins and outs, and/or the components of the system, etc. Stated otherwise, each “non-empty” box of the matrix (example CC1 and CC3 for the airbag system) is related to the set of the data of the electrical function of the configuration(s) concerned.

Moreover, the graphical generation of the diagrams taking time, if two different configurations of vehicles comprise two identical electrical systems, it is preferable to avoid carrying out the same work twice for these two configurations. Thus, the step of generating the set of elements E3 can comprise a step E3-1 of identifying at least two elements each comprising an electrical system of the same nature and whose associated vehicle configurations are distinct, and a step E3-2 of comparing parameters of the electrical systems of the same nature so that if the latter are identical, only one element of said at least two elements is included with the set of elements. Of course, if the two systems are different it follows from this that both belong to the set of elements. Within the framework of the example of the matrix, in case of identity between at least two electrical systems only one association will be produced. In fact, for the example of the airbag, if the electrical function related to the configuration CC1 is identical to that related to an existing configuration CC2 (in terms of components and of ins-outs), and if the electrical function related to the configuration CC3 is identical to that related to an existing configuration CC4, only two airbag electrical functions will be retained from the matrix: the first will have the final configuration CC1 or CC2, and the second the final configuration CC3 or CC4.

The identity of two electrical systems may be defined, as mentioned previously, by the fact that these electrical systems each comprise the same components and the same ins-outs.

The latter operation makes it possible, in the course of a subsequent method of graphical generation of the diagrams, for two totally identical diagrams to be processed just once by producing only the electrical diagrams associated with the electrical systems arising from the set of elements. It is clearly understood that the computational resources will then be greatly unburdened since they will not redo the same work twice.

It is understood from what has just been stated that a need exists to preserve certain information, in particular the association of an electrical diagram to be generated with a particular vehicle configuration even if the latter has not been added to the matrix so as to avoid the presence of doubletons during the graphical generation. This association will allow for example an after-sales workshop that has to occupy itself with a vehicle in particular to have access to all the graphical electrical diagrams of the various systems, whatever the vehicle. Thus, the method can comprise a linking step E3-3 linking configurations of vehicles, whose electrical systems have identical contents, to one and the same item of information, in particular by an electrical diagram identifier. This linking step E3-3 can be carried out subsequent to the comparison step E3-2 if an identity of at least two electrical systems is determined. For example, the linking step E3-3 consists in adding to the database records linking an element of the set of elements to several configurations of the configuration list when the corresponding electrical diagrams are identical. It will then be possible for a workshop, that has identified a vehicle configuration, to retrieve a particular electrical diagram by virtue of this link. Stated otherwise, a generated graphical electrical diagram can be associated with a plurality of vehicle configurations. In fact, according to a concrete example of use, if a vehicle arrives in a workshop for an airbag problem and the configuration of which is CC2, then it will be possible to find the “appropriate” associated electrical function whose final configuration has already been computed, according to this method, in the proposed matrix, the electrical function being the same for CC1 and CC2.

According to an implementation, the step E3 of generating the set of elements comprises, for each electrical system of the corresponding list, a step of verifying the membership of said electrical system in each of the vehicle configurations of the corresponding list. It is understood that in case of positive response to membership it is possible to identify an element to potentially be added to the set of elements. Stated otherwise, the method can comprise a step of forming an element upon each positive verification of membership of the electrical system in a given configuration, said element formed being added to the set of elements or compared with one or more other elements already present in the set of elements so as to determine whether it should be added to the set of elements. This comparison step reverts to that described hereinabove in the sense that an element whose electrical system is identical to another electrical system of an element already present in the set of elements will not be added to the set of elements. In fact, each electrical system, in the list of the electrical systems of a vehicle, is processed, with the aid of this method, to identify the membership of its elements (components and ins-outs), or some of the latter, in each of the configurations proposed in the columns of the matrix. It is the elements retained after this processing that determine the exact content of the electrical system with respect to each of the configurations. Thus, once the processing is terminated for an electrical system (airbag for example) for the set of configurations proposed in the matrix (CC1, CC2, CC3, CC4, . . . etc.), a comparison step can begin to “identify” and group together the “identical contents”, of the electrical system in question, in terms of components and of “ins-outs”. Stated otherwise, it is possible for an electrical system to determine all the associated configurations, and then to group together the identical configurations so that only one of the identical configurations of each group forms part of the set of elements.

Preferably, the method for managing data can thereafter comprise, for each element of the set of elements, a processing step E4 (FIG. 1). This processing step E4 is intended to prepare the plot of each of the elements of the set of elements, in particular so as to facilitate the readability thereof and to optimize the plot time.

As illustrated in FIG. 4, the processing step E4 can comprise, for each of the elements of the set of elements, a step E4-1 in which a model (template) arising from the database is transmitted to the computer, said model comprising a list of identifiers of components of the electrical system, for example of an electrical system for automotive vehicle, and, for each component identifier, a position of said component on the electrical diagram to be generated. In fact, what is transmitted here can comprise records of the database, whose fields are respectively representative of an object corresponding to a component identifier and of an object comprising positioning coordinates. At this juncture, these records make it possible to define each electrical function by a set of components able to ensure the electrical function in question (for example, there will be a list of components associated with an airbag system or else a list of components related to an air-conditioning system). These positioning coordinates can be associated with a benchmark corresponding to a page on which the electrical diagram of the electrical system concerned will have to be plotted. Preferably, the model comprises solely identifiers forming part of the electrical diagram of the electrical system concerned and the positions of these components on the page of the electrical diagram.

The model is in general created by a manager of the library with the agreement and the validation of the manager of the function of the electrical system.

The processing step E4 can furthermore comprise a step E4-2 in which a configuration of the electrical diagram to be generated is determined by the computer. The configuration includes a plurality of connectors. The configuration of the electrical diagram can be determined on the basis of the database which comprises for example, for the electrical system concerned, a list of connectors and their associations with the components. In fact, for the electrical system, the list of components can be supplemented with the associated connectors and the list of ins-outs according to a preprocessing in the database. According to a particular example, the database comprises records associating identifiers of connectors with identifiers of components according to the following relations: a given connector identifier is associated with a single component identifier, a component identifier can be associated with one or more different connector identifiers. Preferably, the configuration determined is chosen from among a plurality of configurations of the electrical diagram. In fact, as mentioned previously, two electrical systems of the same nature may have a different configuration, that is to say comprise one and the same list of components but lists of different connectors and/or ins-outs. For example, a bottom-of-the-range air-conditioning and a top-of-the-range air-conditioning are two electrical systems of the same nature but of different configurations, thus they may comprise the same components positioned at the same locations, however the links between these components are different so that certain functionalities of the top-of-the-range air-conditioning are not activated in the bottom-of-the-range air-conditioning, stated otherwise these two levels of air-conditioning may be represented using the same model.

Once the connectors have been determined via the configuration, the processing step E4 comprises a step of association E4-3, by the computer, of at least one connector of the plurality of connectors with each component. In fact, this can be carried out by simple reading in the database since the content of each electrical system per configuration is already processed (the association is then already known) according to the management method, in particular during the formation of the matrix, thus the result is already in the database and gives a list of components, of connectors and of ins-outs (for the airbag example, the content related to CC1 may be identical to that related to CC2, the same goes for the configurations CC3 and CC4). Preferably, each connector of the plurality of connectors is associated with a component. This association also makes it possible, for example, to compute, or to determine, for each connector a point of attachment of the connector to its corresponding component, the coordinates of the points of attachment then being dependent on the position of the component arising from the model provided. Preferably, the database also comprises for each component a list of points of attachment each intended to cooperate with a connector. According to a particular example, the database comprises records associating identifiers of components with positions (or coordinates) of points of attachment according to the following relation: a given component identifier can be associated with one or more different positions (or coordinates) of points of attachment. If the database does not comprise any such records, these positions of points of attachment can be computed in particular on the basis of the position of said component arising from the model. Initially, it is possible to allot in an unordered manner each connector of each component to a point of attachment. An optimization allowing best positioning of the connectors will be seen subsequently. Such an association can be determined on the basis of records of the database each comprising: the reference of the electrical diagram or more precisely the configuration of the electrical diagram to be generated, the identifier of the component, and a connector identifier. The cross-referencing of these records with the data of the model make it possible to define at least partially and digitally the electrical diagram to be generated.

Finally, the processing step E4 can comprise a step of determination E4-4, by the computer, of a topology of the electrical diagram to be generated, said topology comprising linking elements, each linking element linking at least two connectors, preferably associated with distinct components. This step E4-4 makes it possible to determine how connectors are linked together. The topology is, for example, extracted from the database as a function of the configuration determined, in particular on the basis of the ins-outs (for example on the basis of the data structure corresponding to the element associated with the current electrical diagram and present in the matrix). The topology can be generated on the basis of the data related to each of the “non-empty” boxes of the matrix seen previously. Stated otherwise, the topology can be determined on the basis of records of the database each comprising two identifiers of connectors and a linking element identifier. The cross-referencing of these records with the data of the model and the records relating to the associations between the components and the connectors make it possible to digitally supplement the electrical diagram to be generated.

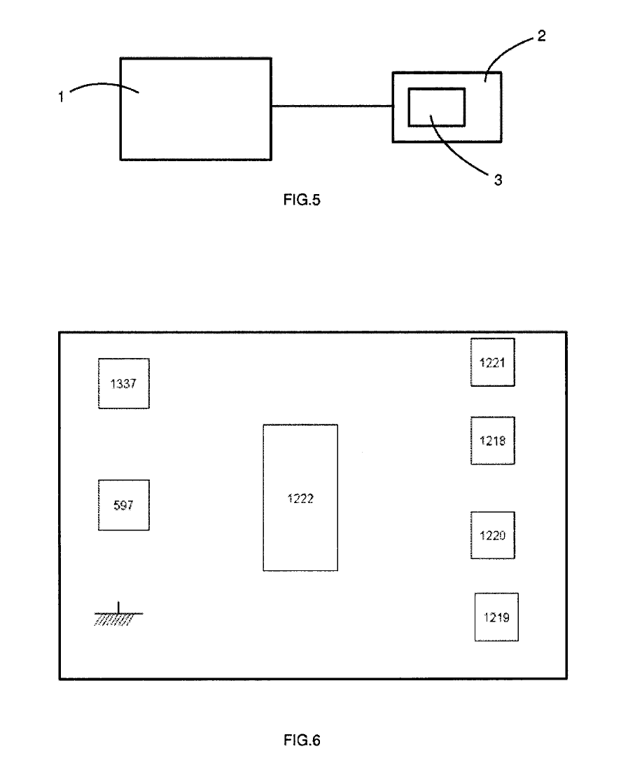

In a general manner applicable to all that has been stated hereinabove, the management method can be implemented as illustrated in FIG. 5 by a computer 1 interfaced with at least one storage medium 2 comprising the database 3. The computer 1 is then able to extract data from the database 3 and/or to inject same by creation or modification.

Moreover, as the electrical diagram can be chosen from among the set of elements, the processing step can comprise a step of determining an identifier relating to the element to be processed from among the set of elements, this identifier then making it possible to choose the appropriate model to be processed.

It is understood that the data processed by the computer in the course of the processing step E4 can be thus processed so as to constitute, for each element of the set of elements, a digital object comprising all the characteristics of an electrical diagram to be generated. Once the digital object has been constituted, the processing step E4 can comprise a step of storing the digital object in the database. The advantage of such a digital object is that it is easy to manipulate in terms of memory and to modify if one wishes to improve it.

Thus, the list of identifiers of components and their positionings, the plurality of connectors, the association of the connectors with the components and the topology of the electrical diagram can be attributes added to the digital object. Stated otherwise, the processing step E4 can comprise a step of forming a digital object comprising the attributes mentioned hereinabove. The aim being that at the end of the processing step E4, the digital object can be drawn while limiting the alterations which generate time loss. Indeed, modification of a generated graphic involves a validation process of non-negligible duration. Stated otherwise, advantageously the steps associated with the processing step E4 are digital only steps and carried out by the computer, in particular steps of alteration of the future graphical plot of the electrical diagram. An alteration step in particular can be an alteration of the position of the connectors at the levels of their associated components so as to avoid the crossover of at least two linking elements on the future graphical electrical diagram.

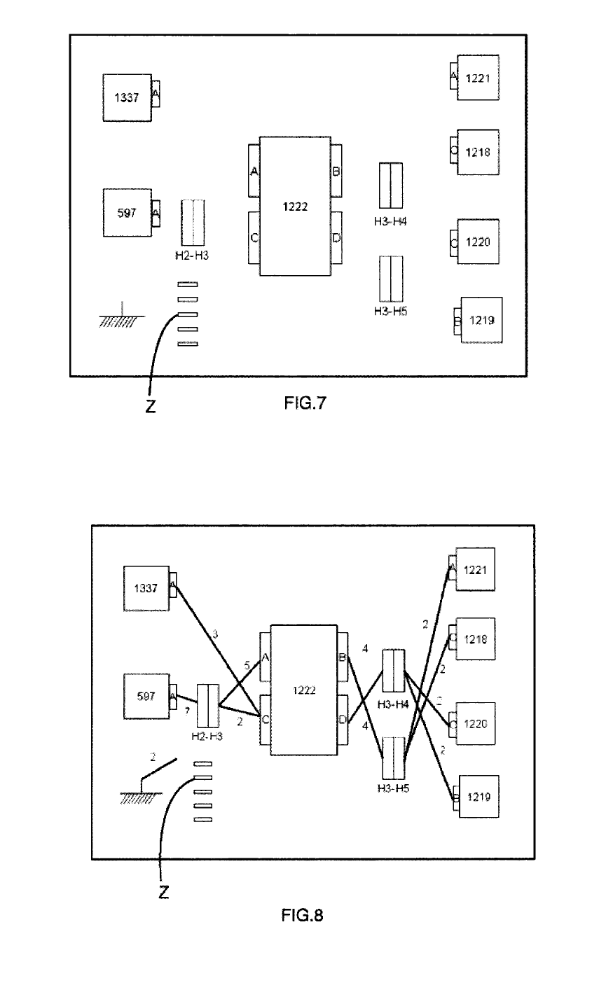

In order to illustrate the processing of the data in the course of the processing step E4 described, FIG. 6 shows a representation of what can be obtained graphically on the basis of the step in which the model is transmitted E4-1. In this FIG. 6, the components are positioned and represented by blocks tagged by their identifiers respectively 1218, 1219, 1220, 1221, 1222, 1337 and 597. Moreover, FIG. 7 illustrates the cross-referencing of the results of the step of transmission of the model with the data making it possible to determine the configuration and the component/connector associations. Seen therein is the association of the connectors (denoted A, B, C, D for the needs of the example) with the components 1218, 1219, 1220, 1221, 1222, 1337 and 597. Moreover, apparent in FIG. 7 are unions H2-H3, H3-H4 and H3-H5 which allow certain linking elements to have common parts and splices Z which make it possible to lengthen the linking elements. When the desired topology is applied, a correspondence table illustrated by the diagram of FIG. 8 is obtained. In FIG. 8, the positioning of the various elements is relatively arbitrary, that is to say that although functional it is not optimized ergonomically. It follows from this that an electrical diagram in this form would still be difficult to read on account of the crossovers of certain constituent linking elements. At the juncture of FIG. 8, the positioning is only in the database and not graphical: the connectors A, B, C and D are simply said to be tied to the component 1222.

Hence, in an optional but preferential manner, still upstream of the graphical production of the electrical diagram, we shall seek to determine, via the processing step E4, improved positioning parameters for the connectors and/or unions so that the most readable possible electrical diagram can be drawn directly by utilizing these data. The problematic issue of the readability of the electrical diagram exhibits a significant impact for after-sales service workshops. Stated otherwise, the final coordinates of the connectors depend on the topology determined. It is in particular possible to consider that the coordinates of the connectors in the benchmark of the page intended to receive the plot of the electrical diagram are determined on the basis of the topology of the electrical diagram so as to minimize the number of crossovers of linking elements when plotting the electrical diagram.

Thus, it may be considered that the digital object mentioned hereinabove will be modified/altered so as to anticipate the future graphical placement of the constituent elements of the electrical diagram.

Hence, the step of associating E4-3 at least one connector with each component can comprise a step of positioning one or more connectors on the basis of data arising from the topology determined and of the model provided. For example, the data arising from the topology making it possible to place a connector relate to at least one linking element length, that is to say a distance between two objects, in particular two connectors or components linked by the linking element, and/or to weights allotted to at least two linking elements. In fact the weight is associated with a linking element linking the two connectors or components.

In particular, according to a first placement rule, the positioning, at the level of a component, of at least one of the connectors associated with one and the same linking element is carried out so as to minimize its length, that is to say the distance between the two objects to be connected. Stated otherwise, a first linking element can be associated with a first connector of a first component and with a second connector of a second component, and the positioning of the first connector at the level of the first component can be carried out so that the distance, between a first point of attachment of the first connector to the first component and a second point of attachment of the second connector to the second component, is a minimum. The points of attachment can have predetermined coordinates, for example stored in the database as mentioned previously, or determinable for example by computation in the sense that the only constraint on the connector is of being, on the future graphic to be produced, in contact with its associated component.

According to a second rule which may or may not be combined with the first rule and which exhibits the advantage of resolving certain ambiguities, each linking element is associated with a weight (in FIGS. 8 and 9, the weights correspond to the digits adjacent to the linking elements linking two connectors or a union and a connector), in particular a weight dependent on a number of ins-outs between two connectors. Hence, the positioning of one or more connectors can depend on the values of the weights of at least two linking elements. According to a preferred example of implementation of the second rule, a first linking element of a first weight can be associated with a first connector of a first component and with a second connector of a second component, and a second linking element of a second weight is associated with the first connector of the first component and with a third connector of a third component, so that the positioning of the first connector is carried out so as to minimize the length of the linking element whose weight is the largest. In this example, the first, second and third components are, preferably, distinct. It results from this second rule that the processing step can comprise a step of allotting a weight to each linking element, said allotted weight being equal to the number of ins-outs associated with said linking element, the number of ins-outs for each linking element being contained in the determined topology of the electrical diagram.

According to a particular implementation of the second rule, the processing step E4 comprises a step of ranking the linking elements as a function of their weights, and the step of positioning the connectors is carried out according to the order of the ranking. For example, the positioning of at least one of the connectors associated with a first linking element present in the ranking onward of the second position of the ranking is carried out while taking into account the positioning already carried out of one or more connectors associated with at least one second linking element whose position in the ranking is higher than that of the first linking element. The ranking is optional since it is not necessary at this juncture. Indeed, it may quite simply entail taking the list of the connectors that are related to the diagram in question and are available in the database (the list being sorted in the increasing order of the identifiers of the associated components) and undertaking the processing in the following manner: for each triplet (Connector_1 of Component_1, Connector_2 of Component_2, Weight), and by using the “Distances” between the various “points of attachment” of Component_1 and Component_2 in the database, there is computed the “best” connector to be positioned at each “point of attachment” according to the two aforementioned rules. In case of conflict between two connectors of the list (that is to say: two connectors at the same point of attachment) it is the first connector positioned that will get the place; the second connector will in this case be placed in the second best place according to the same rules.

The first and/or the second rule results in a graphical diagram whose plot is clearer and more readable. Typically, the application of the first and second rules to the connectors A and C of the component 1222 makes it possible to pass from the positioning of FIG. 8 to that of FIG. 9. These two rules taken alone or in combination make it possible to deal with a problematic issue of economies of cycles of the computer.

The person skilled in the art will be able to determine other types of rankings making it possible to generate a definitive and optimal positioning of the connectors at the level of the components in such a way as to limit in a general manner the aggregate length of the linking elements, avoid crossovers of linking elements, etc.

In an electrical diagram that it is sought to generate, the linking elements may all be distinct or share common parts. For example the linking elements can comprise unions H2-H3, H3-H4, H3-H5 (FIGS. 7 to 9) making it possible to fuse a part of at least two linking elements, as well as splices Z (FIGS. 7 to 9) making it possible to lengthen a linking element. The unions are advantageously processed according to the same rules as the components (a point of attachment of a union being situated in the middle of each left and right side). Concerning the splices, there is no specific processing since they will be positioned directly in the last step of the method directly on the graphic.

The presence of a union is decided by the person skilled in electronic electrical architecture and is not related to the number of connectors to be linked. In FIG. 8, two linking elements of the electrical diagram share a branch in common, and the method can comprise a step of positioning at least one union intended to link, via associated branches, at least three connectors. In FIG. 8, two linking elements of the electrical diagram share a branch in common, and the method can comprise a step of positioning at least one union intended to link, via associated branches, at least three corresponding connectors. Hence, it is understood that the various associated branches all converge toward the union so as to each be linked, on the one hand, to one of the connectors and, on the other hand, to the union. Preferably, this positioning is such that the length, in particular aggregate or average, of the branches associated with said union is a minimum or is decreased. When the electrical diagram comprises several unions, these can be positioned by applying the principles of the two rules given hereinabove. It is moreover by applying the first and second rules that the unions H3-H5 and H3-H4 have been repositioned from FIG. 8 to FIG. 9. Returning to the examples given hereinabove, a union can replace one of the connectors aimed at in the first and/or second rules, in particular replace the first connector (of course, in this case it is understood that the union is not associated with the first component but is for example intended to be linked by a corresponding linking element to the first connector of the first component).

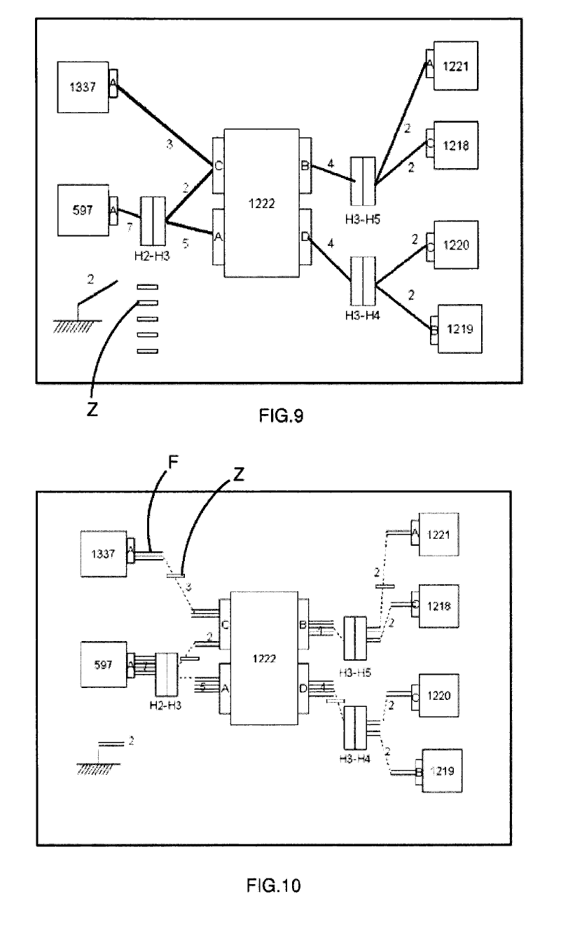

Moreover, as illustrated in FIG. 10, the processing step can furthermore comprise a step of characterizing the linking elements making it possible to generate a wire F for each signal traveling in all or part of a linking element. Each wire can be associated with a connection terminal, if appropriate, of a connector or of a union. Moreover, in this Figure the splices Z have also been placed in an apt manner.

It is understood from what has been stated hereinabove that the implementation of the management method and in particular of the processing step makes it possible thereafter to very rapidly obtain optimized electrical diagrams.

Stated otherwise, a method of graphical generation of electrical diagrams can comprise (as illustrated in FIG. 11) a step EG1 of implementing the management method such as described, and a step of graphical generation EG2 (that is to say of plotting on a page), for each element of the set of elements, of an electrical diagram of the associated electrical system (in particular on the basis of the digital object aimed at hereinabove) by transmission of data, in particular by the computer, relating to said element to a drawing device, in particular a device for digital paper printing in image form or in vector form.

All that has been stated hereinabove in conjunction with the invention allows a considerable time saving in the generation of electrical diagrams since the graphically generated diagrams will directly be the appropriate ones, notwithstanding minor modifications. Moreover, generating an appropriate positioning of the connectors makes it possible to improve the quality of the diagrams representing the electrical systems as well as their readabilities.

Phases of studies have shown a non-negligible time saving of up to as much as 80%.

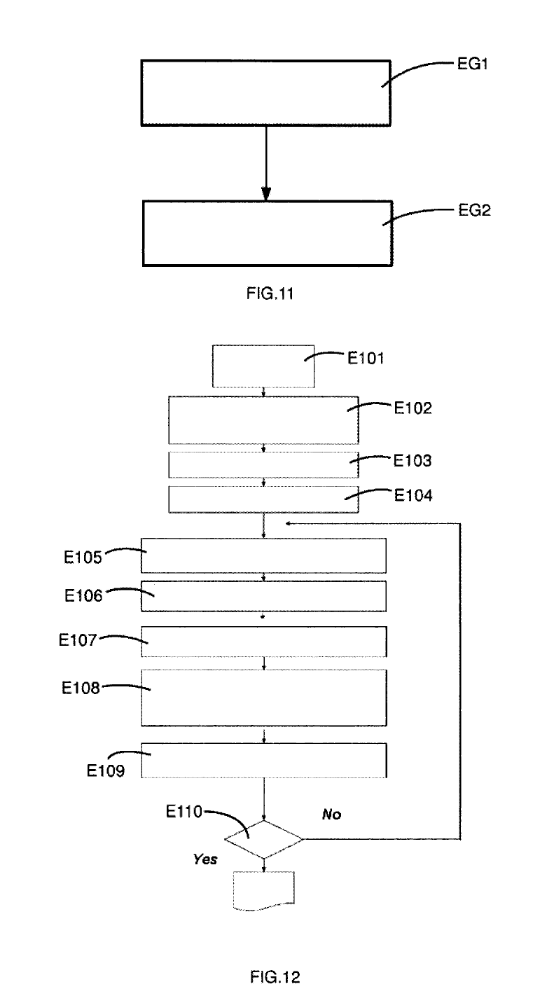

According to a particular example of the processing step illustrated in FIG. 12, the input data of the processing step are a list E101 of electrical systems (that is to say the set of elements in the present case) and of their ins-outs, on the basis of these input data a library of models is created E102. Stated otherwise, each model can correspond to an electrical diagram. Each model comprises a list of identifiers of components and their positionings on the diagram to be generated. A correspondence E103 is established thereafter between each electrical system and a model, in particular to determine the configuration. Once this correspondence has been established, each electrical system will be processed E104 in the following manner:
the connectors are added E105 to the components, and the optional unions and splices in particular as a function of the input data,
the linking elements are added E106 between the connectors to mark the presence of an electrical signal between two connectors,
a weight is allotted E107 to each linking element, said weight being dependent on the number of ins outs associated with the linking element,
the final positioning of the connectors is computed E108 by applying the first and second rules described in greater detail hereinabove,
each linking element is processed by deploying E109 the signals to be connected on the pins of each connector.

If the electrical system which has just been processed is the last then the step of processing the data set (YES output of step E110) is exited, otherwise we return on output to step E104 (NO output of step E110) so as to process a new data set associated with a new electrical diagram. Preferably, the electrical systems of the list are all different, for example the list can comprise systems that differ in function such as an airbag or a vehicle brake or systems that are similar in function such as two airbag systems but whose ins-outs are different. This makes it possible to avoid carrying out the same thing twice.

Preferably each component that we shall seek to draw is associated with a symbol. This symbol may comprise one or more positions of points of attachment each intended to receive a connector. The coordinates of these points of attachment can be computed as a function of the position of the corresponding component and of the shape of the associated symbol. Each symbol can be added to the digital object. A symbol can be associated with a dynamic creation mode or a predefined creation mode. The dynamic creation mode makes it possible to create the shape of the symbol at the moment of the graphical plotting of the electrical diagram whereas the predefined creation mode makes it possible to fetch an already drawn symbol from a database, in particular a library of symbols under the responsibility of a librarian. This makes it possible to avoid the unwieldy management of the so-called “standard” symbols in the database and to opt for dynamic creation except for the complex symbols containing complex internal drawings.

The invention also relates to a data recording medium readable by a computer, on which is recorded a computer program comprising computer program code means for the implementation of the steps of one or more of the methods described hereinabove.

The invention also relates to a computer program comprising a computer program code means suitable for carrying out the steps of one or more of the methods described hereinabove, when the program is executed by the computer.

Moreover, a method of maintenance of a device, in particular of an automotive vehicle, can comprise a step of hooking a diagnostic system up to the device, a step of identification by the diagnostic system of a failed electrical system of the device, a step of display, or of printing on paper, of the corresponding electrical diagram such as generated by the method of graphical generation of electrical diagrams.

1-10. (canceled)

11. A method for managing data relating to automotive vehicles with a view to subsequent graphical generation of electrical diagrams of electrical systems, the method comprising:
transmitting to a computer a collection of data relating to electrical systems of automotive vehicles and to configurations of automotive vehicles, the collection arising from a database;
selecting, by the computer, on the basis of the collection of data, a list of electrical systems and a list of vehicle configurations;
generating a set of elements by the computer, each element of the set comprising an electrical system arising from the list of electrical systems and an associated vehicle configuration arising from the list of configurations, and each element determining, or determining potentially, an electrical diagram to be generated.

12. The method as claimed in claim 11, wherein the generating the set of elements comprises:
identifying at least two elements each comprising an electrical system of same nature and whose associated vehicle configurations are distinct; and
comparing parameters of the electrical systems of the same nature so that if they are identical, only one element of the at least two elements is included in the set of elements.

13. The method as claimed in claim 11, further comprising linking vehicle configurations whose electrical systems have identical contents, to one and a same item of information, or by an electrical diagram identifier.

14. The method as claimed in claim 11, wherein the generating the set of elements comprises, for each electrical system of the corresponding list, verifying membership of the electrical system in each of the vehicle configurations of the corresponding list.

15. The method as claimed in claim 14, further comprising forming an element upon each positive verification of membership of the electrical system in a given configuration, the element formed being added to the set of elements or compared with one or more other elements already present in the set of elements to determine whether it should be added to the set of elements.

16. The method as claimed in claim 11, wherein the generating the set of elements comprises filling a matrix each row of which is associated with an electrical system and each column of which is associated with a vehicle configuration, each row of the matrix comprising at least one association with a column of the matrix, the association corresponding to an element of the set of elements.

17. The method as claimed in claim 16, wherein the association of a row of the matrix and of a column of the matrix corresponds to placing at this location of the matrix a pointer to a structure of data of electrical functions comprising contents of the electrical system associated with the configuration, or a list of ins and outs.

18. The method as claimed in claim 11, further comprising, for each element of the set, a processing comprising:
transmitting a model arising from a database to the computer, the model comprising a list of identifiers of components of the electrical system and, for each component identifier, a position of the component on the electrical diagram to be generated;
determining, by the computer, a configuration of the electrical diagram to be generated, the configuration including a plurality of connectors;
associating, by the computer, with each component at least one connector of the plurality of connectors;
determining, by the computer, a topology of the electrical diagram to be generated, the topology comprising linking elements, each linking element linking at least two connectors.

19. A method of graphical generation of electrical diagrams, comprising:
implementation of the method for managing data as claimed in claim 11;
graphical generation, for each element of the set of elements, of an electrical diagram of the associated electrical system by transmission of data relating to the element to a drawing device.

20. A non-transitory data recording medium readable by a computer, on which is recorded a computer program comprising computer program code means for implementation of the method as claimed in claim 11.
